(19) United States
(12) Patent Application Publication
(10) Pub. No.: US 2019/0377770 A1
(43) Pub. Date: Dec. 12, 2019

(54) METHOD FOR RE-ENTRY PREDICTION OF UNCONTROLLED ARTIFICIAL SPACE OBJECT

(71) Applicant: KOREA ASTRONOMY AND SPACE SCIENCE INSTITUTE, Daejeon (KR)

(72) Inventor: Eun Jung Choi, Daejeon (KR)

(21) Appl. No.: 16/146,157

(22) Filed: Sep. 28, 2018

(30) Foreign Application Priority Data
Jun. 10, 2018 (KR) 10-2018-0063148

(51) Int. Cl. G06F 17/13; G01C 21/24; B64G 1/10

(52) U.S. Cl. CPC G06F 17/13; B64G 1/10; G01C 21/24

(57) ABSTRACT

A method for re-entry prediction of an uncontrolled artificial space object, the method including: calculating an average semi-major axis and an argument of latitude by inputting two-line elements or osculating elements of an artificial space object at two different time points; calculating an average semi-major axis, argument of latitude, and atmospheric drag at a second time point; estimating an optimum drag scale factor while changing the drag scale factor; predicting the time and place of re-entry of an artificial space object into the atmosphere by applying the estimated drag scale factor. Here, orbit prediction is performed by using a Cowell's high-precision orbital propagator using numerical integration from the second time point to a re-entry time point.

### CROSS REFERENCE TO RELATED APPLICATION

The present application claims priority to Korean Patent Application No. 10-2018-0063148, filed Jun. 10, 2018, the entire contents of which is incorporated herein for all purposes by this reference.

### BACKGROUND

### Technical Field

The disclosure relates to a method for re-entry prediction of an artificial space object and, more particularly, to a method for re-entry prediction of an uncontrolled artificial space object by using a drag scale factor estimation (DSFE) method.

### Background Art

The re-entry of an uncontrolled artificial space object of 1 ton or more is highly likely to cause damage to the ground. Therefore, the domestic response manual for a crash and collision of an artificial space object specifies that a crisis alert for the re-entry status of the space object is issued when an artificial space object reaches an altitude of 250 km or less. Accordingly, it is very important to provide accurate re-entry prediction information quickly in order to predict the re-entry status and risk of damage by artificial space objects.

Particularly, when artificial space objects fall and reach an altitude of 250 km, the artificial space objects begin the re-entry process into the atmosphere within about one month, and at the re-entry of an artificial space object with a weight of 1 ton or more, fragments of about 10 to 40% of the artificial space object reach the earth's surface. Particularly, the re-entry of an uncontrolled artificial space object is difficult to predict, which results in loss of lives and assets on the ground. Therefore, to prepare for the re-entry risk of space objects, a technique of predicting the re-entry risk of space objects is necessary to minimize such risk.

A method for re-entry prediction of an uncontrolled artificial space object in the related art is configured to predict a re-entry time point by using the simplified general perturbations 4 (SGP4) orbit propagator using two-line elements (TLE). However, when comparing the predicted re-entry time point with actual re-entry estimation time point and place, the prediction accuracy is very low, whereby there is a problem of not being applied to the re-entry status of the actual space object.

### SUMMARY

In order to solve the above problems, the disclosure provides a method for re-entry prediction of an uncontrolled artificial space object which is configured to accurately predict an expected time point and place of a re-entry of the space object by using a drag scale factor estimation (DSFE) method.

In order to achieve the above object, an embodiment of the disclosure provides a method for re-entry prediction of an uncontrolled artificial space object, the method includes: calculating an average semi-major axis and an argument of latitude by inputting two-line elements (TLE) or osculating elements of the artificial space object at two different time points; calculating an average semi-major axis, an argument of latitude, and an atmospheric drag at a second time point of the two different time points by performing orbital propagation with a Cowell's high-precision orbital propagator using numerical integration up to the second time point, the orbital propagation being performed by applying an initial drag scale factor, which is an arbitrary constant, to orbit information at the first time point; estimating an optimum drag scale factor while changing the drag scale factor until error becomes smaller than a random convergence value by comparing the predicted average semi-major axis or the argument of latitude with a preset average semi-major axis or a preset argument of latitude at the second time point; and predicting time and place of re-entry of the artificial space object into the atmosphere by performing orbit prediction with the Cowell's high-precision orbital propagator using numerical integration from the second time point to a re-entry time point and being applied with the estimated drag scale factor.

The two-line elements (TLE) may be converted into the osculating elements and an average orbit may be calculated in a true-of-date (TOD) coordinate system.

The convergence value may be a position error arbitrarily determined by a user.

As described above, according to the disclosure, the atmospheric re-entry time and place of an uncontrolled artificial space object can be precisely predicted by using the DSFE method.

### BRIEF DESCRIPTION OF THE DRAWINGS

The above and other objects, features and other advantages of the disclosure will be more clearly understood from the following detailed description when taken in conjunction with the accompanying drawings, in which:

FIG. 1 is a flowchart illustrating a method for re-entry prediction of an uncontrolled artificial space object according to a first embodiment of the disclosure;

FIG. 2 is a flowchart illustrating a method for re-entry prediction of an uncontrolled artificial space object according to a second embodiment of the disclosure; and

FIG. 3 is a flowchart illustrating a method for re-entry prediction of an uncontrolled artificial space object according to a third embodiment of the disclosure.

### DETAILED DESCRIPTION

Hereinafter, exemplary embodiments of the disclosure will be described in detail with reference to the accompanying drawings, which will be readily apparent to those skilled in the art to which the disclosure pertains for the convenience of the person skilled in the art to which the disclosure pertains. The disclosure may, however, be embodied in many different forms and should not be construed as limited to the embodiments set forth herein.

Hereinafter, a method for re-entry prediction of an uncontrolled artificial space object according to embodiments of the disclosure will be described.

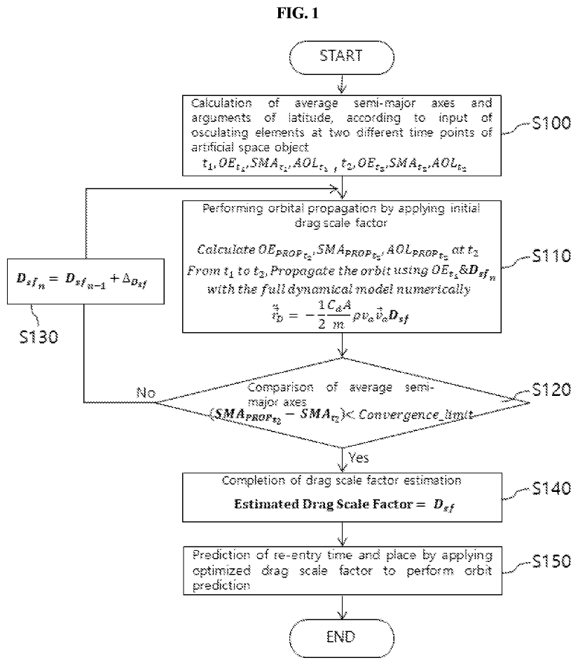

FIGS. 1 to 3 are flowcharts illustrating a method for re-entry prediction of an uncontrolled artificial space object according to first to third embodiments of the disclosure, respectively.

Referring to FIGS. 1 to 3, in the method for re-entry prediction of an uncontrolled artificial space object according to the disclosure, first, at step S100, S200, or S300, the average semi-major axes SMAₜ_{₁} and SMAₜ_{₂} and the arguments of latitude AOLₜ₁ and AOLₜ₂ of the artificial space object are calculated by inputting initial orbital elements OEₜ_{₁} and OEₜ_{₂} at two different time points t₁ and t₂. Here, the orbital elements may be osculating elements or two-line elements (TLE). When the orbital elements are the two-line elements, the two-line elements are converted into osculating elements and the osculating elements may be used to calculate an average orbit in a TOD (True of Date) coordinate system.

Next, at step S110, S210, or S310, orbit propagation is performed up to the second time point t₂ by applying an initial Drag Scale factor D_{sf}_{₀}, which is an arbitrary constant, to the orbit information of the first time point t₁. At this time, the orbital propagation calculates the average semi-major axis SMAPROPₜ_{₂}, argument of latitude AOLPROPₜ_{₂}, and atmospheric drag

$$\text{?} = - \frac{1}{2} \frac{{C}_{d} A}{m} p \text{?} {\vec{υ}}_{α} {D}_{sf}$$

$$\text{?} \text{indicates text missing or illegible when filed}$$

according to the orbital element OEPROPₜ_{₂} at the second time point t₂ predicted by a Cowell's high-precision orbital propagator using numerical integration, wherein C_{d} is a drag coefficient, A is a cross-sectional area, m is the mass, ρ is a degree of tightness, \vec{ν_{α}} is a velocity vector, and ν_{α} is a velocity vector size.

The Cowell's high-precision orbital propagator is an algorithm to obtain the position and velocity of an artificial space object at an arbitrary time based on the consideration of all perturbing forces such as earth's gravitational field, atmospheric influence, attraction of sun and moon, solar radiation pressure, etc. that affect artificial space objects. Since this technique is widely known in the field, detailed description will be omitted.

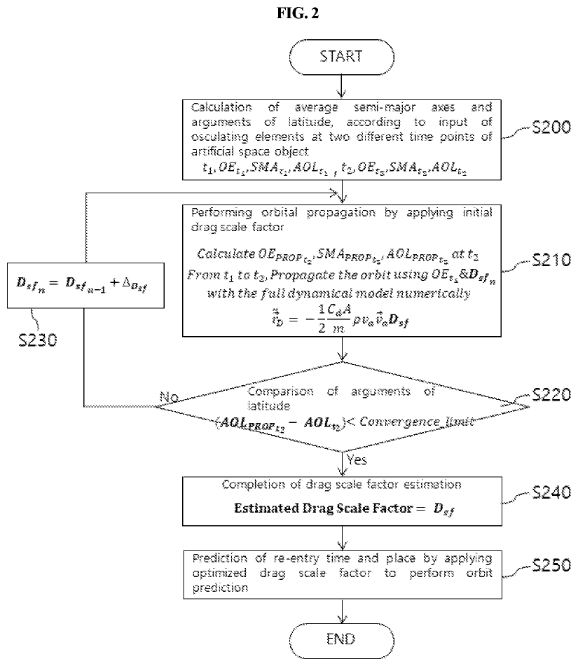

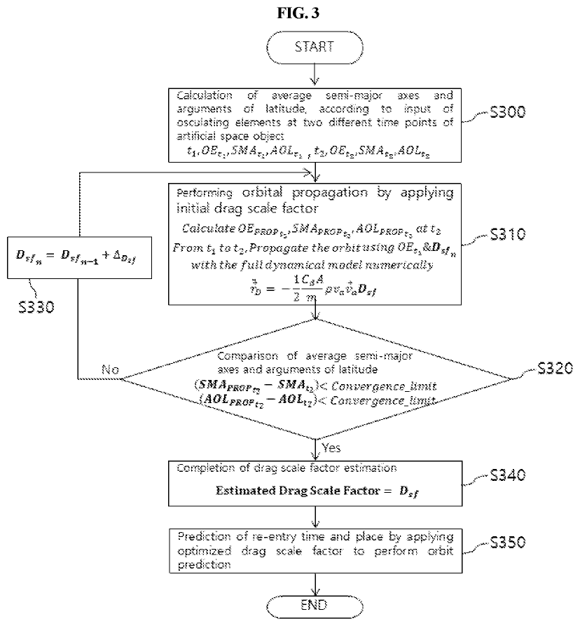

Next, when the error of a comparative value of average semi-major axes of FIG. 1, the error of a comparative value of arguments of latitude of FIG. 2, or the error of any one of the comparative value of average semi-major axis and the comparative value of arguments of latitude of FIG. 3 is compared with a convergence value at step S120, S220, or S320, and the error reaches a minimum, the optimal drag scale factor is determined at step S140, S240, or S340. If not, the procedure is repeated while changing the drag scale factor at step S130, S230, or S330. In other words, by comparing the average semi-major axis SMAPROPₜ_{₁} or argument of latitude value AOLPROPₜ_{₁} estimated by reflecting the drag scale factor D_{sf} from the first time point t₁ to the second time point t₂ with the initially input average semi-major axis SMAₜ_{₂} or initially input argument of latitude value AOLₜ_{₂} at the second time point t₂, the optimum drag scale factor D_{sf} is found while changing the drag scale factor until the error becomes smaller than the convergence value. Here, the convergence value is a position error, for example, 10⁻⁴ km and so on, which is set arbitrarily by a user.

Next, orbit prediction is performed by applying an optimized drag scale factor D_{sf}, through the Cowell's high-precision orbital propagator using numerical integration from the second time point t₂ to a re-entry time point. Thus, the accuracy of prediction of re-entry time and place within 100 km altitude is improved, and atmospheric re-entry time and place (latitude, longitude, and altitude) of an uncontrolled artificial space object are predicted at step S150, S250, or S350.

While the disclosure has been particularly shown and described with reference to exemplary embodiments thereof, the scope of rights of the disclosure is not limited thereto and various modifications and improvements of those skilled in the art using the basic concept of the disclosure defined in the following claims are also within the scope of the disclosure.

1. A method for re-entry prediction of an uncontrolled artificial space object, the method comprising:
calculating an average semi-major axis and an argument of latitude by inputting two-line elements (TLE) or osculating elements of the artificial space object at two different time points;
calculating an average semi-major axis, an argument of latitude, and an atmospheric drag at a second time point of the two different time points by performing orbital propagation with a Cowell's high-precision orbital propagator using numerical integration up to the second time point, the orbital propagation being performed by applying an initial drag scale factor, which is an arbitrary constant, to orbit information at the first time point;
estimating an optimum drag scale factor while changing the drag scale factor until error becomes smaller than a random convergence value by comparing the predicted average semi-major axis or the argument of latitude with a preset average semi-major axis or a preset argument of latitude at the second time point; and
predicting time and place of re-entry of the artificial space object into the atmosphere by performing orbit prediction with the Cowell's high-precision orbital propagator using numerical integration from the second time point to a re-entry time point and being applied with the estimated drag scale factor.

2. The method according to claim 1, wherein the two-line elements (TLE) are converted into the osculating elements and an average orbit is calculated in a true-of-date (TOD) coordinate system.

3. The method according to claim 1, wherein the convergence value is a position error arbitrarily determined by a user.
